(19) United States
(12) Patent Application Publication
(10) Pub. No.: US 2021/0348012 A1
(43) Pub. Date: Nov. 11, 2021

(54) CONDUCTIVE INK AND CONDUCTIVE ELEMENT ABLE TO BE STRETCHED

(71) Applicant: Zhen Ding Technology Co., Ltd., Taoyuan (TW)

(72) Inventors: LING-LUNG SU, Taoyuan (TW); SHENG-FENG CHUNG, Taoyuan (TW)

(21) Appl. No.: 16/938,005

(22) Filed: Jul. 24, 2020

(30) Foreign Application Priority Data
May 11, 2020 (CN) 202010391946.0

(51) Int. Cl. C09D 11/52; C09D 11/037; C09D 11/108; C09D 11/102; H01B 1/24

(52) U.S. Cl. CPC C09D 11/52; C09D 11/037; H01B 1/24; C09D 11/102; C09D 11/108

(57) ABSTRACT

A conductive ink able to be stretched without significant increase of the resistance includes a flexible resin, a plurality of plastic particles, and a conductive agent. The plastic particles and the conductive agent are mixed in the flexible resin. The conductive agent includes at least one conductive carbon material selected from a group consisting of conductive carbon black and carbon nanotube, and a mass ratio of the conductive carbon material in the conductive ink is in a range from 20% to 40%.

### FIELD

The disclosure relates to conductive elements, and more particularly to a conductive ink able to be stretched and a conductive element made of the conductive ink.

### BACKGROUND

Stretchable materials have been used in artificial skins, robot arms, and smart wearable clothing. The stretchable materials may be prepared based on engineering structure designs. For example, to cause metallic conductive materials to have stretchable property, the metallic conductive materials, such as metallic wirings, are not in themselves stretchable but have a horseshoe or a knitted mesh structure to allow them to extend longer.

However, such materials or structures may only be stretched in a single direction, and the resistance of the stretchable material can greatly increase after numerous stretches. Furthermore, the engineering structure design is complicated and with high cost.

### BRIEF DESCRIPTION OF THE DRAWING

Many aspects of the disclosure can be better understood with reference to the following drawing. The components in the drawing are not necessarily drawn to scale, the emphasis instead being placed upon clearly illustrating the principles of the disclosure.

FIG. 1 is a diagrammatic view of an embodiment of a conductive element including a conductive ink according to the present disclosure.

### DETAILED DESCRIPTION

Implementations of the disclosure will now be described, by way of embodiments only, with reference to the drawings. It should be noted that the embodiments and the features of the present disclosure can be combined without conflict. Specific details are set forth in the following description to make the present disclosure to be fully understood. The embodiments are only portions of, but not all the embodiments of the present disclosure. Based on the embodiments of the present disclosure, other embodiments obtained by a person of ordinary skill in the art without creative efforts shall be within the scope of the present disclosure.

Unless defined otherwise, all technical and scientific terms used herein have the same meaning as commonly understood by one of ordinary skill in the art. The terms used herein in the specification of the present disclosure are only for describing the embodiments, and are not intended to limit the present disclosure. The term “and/or” as used herein includes any combination of one or more related items.

In the embodiments of the present disclosure, for descriptive convenience, but not in limitation of the present disclosure, the term “connection” used in the specification and claims of the present disclosure is not limited to physical or mechanical connection, no matter direct connection or indirect connection. The terms of “up”, “down”, “above”, “below”, “left”, “right”, etc., are only used to indicate the relative position relationship. When the absolute position of the described element changes, the relative position relationship correspondingly changes.

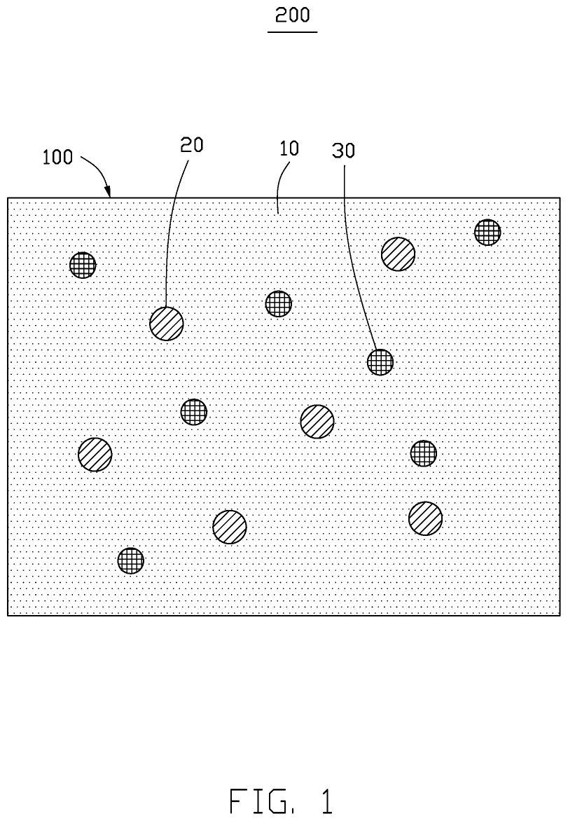

FIG. 1 illustrates an embodiment of a conductive ink 100 able to be stretched. The conductive ink 100 includes a flexible resin 10. A plurality of plastic particles 20 and a conductive agent 30 are dispersed in the flexible resin 10. The conductive agent 30 includes at least one conductive carbon material selected from a group consisting of conductive carbon black and carbon nanotube. A mass ratio of the conductive carbon material in the conductive ink 100 is in a range from 20% to 40%.

The conductive ink 100 of the present disclosure has alternate flexible structures (i.e., the flexible resin 10) and rigid structures (i.e., the plastic particles 20) in any direction, which allows the conductive ink 100 to be stretched and have a degree of elasticity in any direction. Furthermore, adding the plastic particles 20 into the flexible resin 10 simplifies the process and reduces the cost. Moreover, when using the conductive ink 100 to make a conductive element 200, the plastic particles 20 increase the recovery rate of the conductive element 200 after stretching (stretched recovery rate), which may reach 98.5%. By changing the mass ratio of the plastic particles 20 in the conductive ink 100, a stretchable rate of the conductive element 200 may be changed within a certain range to meet specific requirements. The stretchable rate is defined as a ratio of a current length L of the conductive element 200 after being stretched with respect to an initial length L₀ of the unstretched conductive element 200.

In addition, the conductive carbon material is used as a conductive agent 30. Compared with the conventional conductive agent of metal particles, the conductive carbon material decreases a change in resistance of the conductive element 200 (less than 10%) after being stretched. The change in resistance (resistance change rate) is defined as a ratio of a difference between a current resistance value of the conductive element 200 after being stretched and an initial unstretched resistance value (i.e., R−R₀) with respect to the initial resistance value R₀.

The flexible resin 10 is a resin that is soft and bendable after being solidified. In at least one embodiment, a mass ratio of the flexible resin 10 in the conductive ink 100 is in a range from 60% to 80%. When the mass ratio of the flexible resin 10 is less than 60%, the conductive element 200 made of the conductive ink 100 is insufficiently stretchable. On the other hand, when the mass ratio of the flexible resin 10 is greater than 80%, the mass ratio of the conductive agent 30 or the plastic particles 20 in the conductive ink 100 needs to be decreased, which may cancel the conductivity of the conductive ink 100 or the resistance change rate after being stretched, and may not improve the stretched recovery rate of the conductive element 200.

In at least one embodiment, the plastic particles 20 are made of plastic including at least one of polyvinyl chloride (PVC), polymethyl methacrylate (PMMA), polyethylene (PE), and nylon.

In at least one embodiment, the conductive agent 30 may further include other conductive carbon materials such as graphite and graphene, and also metal powders. The metal powder may be dendritic, such as dendritic silver or dendritic silver-coated copper. The metal powders increase the conductivity of the conductive ink 100, but also decrease a wash resistance of the conductive ink 100 and increase the resistance change rate of the conductive ink 100 after being stretched. Therefore, in the embodiment, a mass ratio of the conductive carbon material to the metal powders is greater than 2:1. When the conductive agent 30 includes both the conductive carbon material and the metal powders, the resistance change rate of the conductive element 200 after being stretched is smaller than that of the conductive element 200 which only uses the metal particles as the conductive agent 30, but is also greater than that of the conductive element 200 which only uses the conductive carbon material as the conductive agent 30.

In at least one embodiment, the conductive ink 100 may be a solvent-type conductive ink.

The flexible resin 10 includes at least one of rubber-based resin and polyurethane-based resin. The rubber-based resin is selected from a group consisting of styrene-ethylene-butene-styrene block copolymer (SEBS) rubber, styrene-butadiene-styrene block copolymer (SBS) rubber, and any combination thereof, which may further increase the stretched recovery rate of the conductive element 200. The polyurethane-based resin may be water-based polyurethane or oil-based polyurethane.

The conductive ink 100 further includes a solvent. The solvent may have a boiling point greater than 100 degrees Celsius, such as at least one of toluene, high-flash aromatic naphtha (such as high-flash aromatic naphtha-100 or high-flash aromatic naphtha-150), and ethylene glycol butyl ether. The plastic particles 20 and the conductive agent 30 may be dispersed in the solvent.

During preparation, the flexible resin 10 is added to the solvent to obtain a mixed solution. Then, the plastic particles 20 and the conductive agent 30 are mixed and dispersed in the mixed solution to obtain the solvent-based conductive ink 100. The plastic particles 20, the conductive agent 30, and the mixed solution may be dispersed by a three-drum, a homogenizer, or a planetary disperser.

In another embodiment, the conductive ink 100 may also be a foam-type conductive ink.

The difference between the foam-type conductive ink and the solvent-type conductive ink is that the flexible resin 10 of the foam-type conductive ink includes two-fluid polyurethane. The two-fluid polyurethane includes a polyol and a diisocyanate mixed in a certain ratio. After being stirred, the mixed polyol and diisocyanate may be loaded into a mold and foamed to form a polyurethane foam. A density of the two-fluid polyurethane is less than 30 m³/kg. When the density of the two-fluid polyurethane is greater than or equal to 30 m³/kg, the conductivity and the foamability are poor, and the density may be greatly affected after adding the conductive agent 30.

The polyol includes at least one of polypropylene glycol (PPG), polytetramethyl ether glycol (PTMEG), and polyether polyol. The diisocyanate includes at least one of toluene diisocyanate (TDI), diphenylmethane diisocyanate (MDI), aliphatic isocyanate (HDI), isophorone diisocyanate (IPDI), hydrogenated phenylmethane diisocyanate (H12MDI), and oligomeric diisocyanates.

During preparation, the plastic particles 20 and the conductive agent 30 are mixed and dispersed in the polyol. Then, the diisocyanate is added to obtain the foam-type conductive ink. The foam-type conductive ink is emulsified and stirred at a certain speed, and loaded into a mold to foam, thereby obtaining the polyurethane foam.

To improve the foaming property of the foamed material, the conductive ink 100 may further include at least one of a chain extender, a foaming structure stabilizer, an ammonia catalyst, a metal catalyst, a foaming agent, and a reinforcing additive. In addition, different pigments may be added depending on the actual needs.

The chain extender includes short-chain polyols, such as at least one of ethylene glycol (EG), butylene glycol (BG), diethylene glycol (diethylene glycol), triethylene glycol (triethylene glycol), 1,2-propanediol (1,2-propanediol), 1,3-propanediol (1,3-propanediol), and 1,6-hexanediol (1,6-hexanediol).

The foaming structure stabilizer includes polysiloxane.

The ammonia catalyst accelerates the reaction between the polyol and the diisocyanate. The ammonia catalyst includes triethylamine (TEA).

The metal catalyst accelerates the reaction between the polyol and the diisocyanate. The metal catalyst includes at least one of stannous octoate (T9) and dibutyltin dilaurate (T12).

The foaming agent includes at least one of hydrofluorocarbon (HFC), water, methylene chloride, and acetone.

The reinforcing additive increases the strength and the hardness of the foamed material. The reinforcing additive includes at least one of calcium carbonate and silicon oxide.

In yet another embodiment, the flexible resin 10 of the foam-type conductive ink may further include at least one of thermoplastic resin or thermosetting resin.

The thermoplastic resin may include at least one of polystyrene (PS), polyethylene (PE), polyvinyl chloride (PVC), acrylonitrile-butadiene-styrene copolymer (ABS), polycarbonate (PC), polyester, nylon, and polyoxymethylene.

The thermosetting resin may include at least one of polyurethane (PU), polytrimeric isocyanate resin, phenolic resin, urea-formaldehyde resin, self-foaming epoxy resin, composite epoxy resin, polyorganosiloxane (sponge), polyimide (self-foaming), and polyimide (composite).

The conductive ink 100 further includes a foaming agent, including at least one of hydrofluorocarbon (HFC), water, methylene chloride, and acetone.

During preparation, the plastic particles 20 and the conductive agent 30 are mixed and dispersed in the flexible resin 10. Then, the foaming agent is added to obtain the foam-type conductive ink. The foam-type conductive ink is emulsified and stirred at a certain speed, and loaded into a mold to be foamed, thereby obtaining a foam-type material.

FIG. 1 also illustrates an embodiment of the conductive element 200. The conductive element 200 is prepared by the conductive ink 100 through printing (such as screen printing or steel plate printing), coating, or wire drawing. When the conductive ink 100 is the foam-type conductive ink, the conductive ink 100 needs to be foamed in a mold. The conductive element 200 may be a conductive wire and a sensing electrode.

The preparation method of the conductive element 200 is simple and has a low cost.

### Example 1

SEBS rubber, PVC particles, and conductive agent were mixed and dispersed to obtain the conductive ink. The conductive agent was conductive carbon black (manufactured by CABOT, model number VXC72). The mass ratio of the SEBS rubber in the conductive ink was 68.72%. The mass ratio of the PVC particles in the conductive ink was 10%. The mass ratio of the conductive agent in the conductive ink was 21.28%.

### Example 2

The difference from Example 1 is that the plastic particles were PMMA particles.

### Example 3

The difference from Example 1 is that the flexible resin was water-based PU.

### Example 4

The difference from Example 1 is that the flexible resin was oil-based PU.

### Example 5

The difference from Example 1 is that the conductive agent further included metal powders (dendritic silver-coated copper). The mass ratio of the metal powders in the conductive ink was 7.09%, and the mass ratio of the conductive carbon material in the conductive ink was 14.19%.

### Example 6

The difference from Example 1 is that the conductive agent further included metal powder (dendritic silver-coated copper). The mass ratio of the metal powders in the conductive ink was 4.256%. The mass ratio of the conductive carbon material is the conductive ink was 17.024%.

### Comparative Example 1

The difference from Example 1 is that no plastic particles were contained. The mass ratio of the SEBS rubber in the conductive ink was 78.72%.

### Comparative Example 2

The difference from Comparative Example 1 is that the flexible resin further included SBS rubber. The mass ratio of the SEBS rubber in the conductive ink was 68.72%, and the mass ratio of the SBS rubber in the conductive ink was 10%.

### Comparative Example 3

The difference from Comparative Example 1 is that the mass ratio of the SEBS rubber in the conductive ink was 24.8%. The conductive agent further included metal powders (dendritic silver-coated copper). The mass ratio of the metal powder in the conductive ink was 74.4%, and the mass ratio of the conductive carbon material in the conductive ink was 0.8%.

### Comparative Example 4

The difference from Comparative Example 1 is that the mass ratio of the SEBS rubber in the conductive ink was 24.8%. The conductive agent was entirely of metal powders (dendritic silver-coated copper). The mass ratio of the metal powders in the conductive ink was 75%.

The sensing electrodes were prepared according to the conductive inks in Examples 1-6 and Comparative Examples 1-4. The initial resistance value, the resistance value after 50 washing and drying processes, the adhesion, the stretched recovery rate, and the stretchable number of the sensing elements were tested.

The initial resistance value was characterized by a square resistance, which was tested by following steps. 1. The sample was fixed to a measuring rod, and the resistivity p of the sample was tested. 2. The sample was placed on a glass sheet, and the thickness t of the sample was observed by a high-power optical microscope. 3. The initial resistance value R₀ was calculated by the formula of R₀=ρ/t.

The resistance value after 50 washing and drying processes was tested by following steps. 1. The sample was cut into 50 cm×50 cm by an AATCC sampling rule, and was weighed to be 8 kg. 2. A washing machine and a dryer were provided. The water level of the washing machine was set to at medium. The washing program was set at regular. 92 g of WOB washing powders was dissolved in warm water and added to the washing machine. The washing machine was started. Then, the sample after being washed was taken out of the washing machine, and placed in the drying machine. The drying program and the drying temperature were set, and the drying machine was started. 3. The sample was placed back into the washing machine and the drying machine, and the washing and drying steps were repeated for 50 times. 4. The sample was placed in a room having constant temperature and constant humidity for at least 4 hours, and then the resistance value after the 50 times was measured by the above method.

The adhesion was tested by following steps. 1. The surface of the sample was divided into 100 squares with a 100-grid knife, each having a size of 1 mm×1 mm. The sample was then adhered to the 100-grid by a 3M tape. 2. The air between the sample and the tape was removed. The sample stayed static for about 30 seconds, and then quickly torn off at an angle of 90 degrees. 3. The tearing-off step was repeated 3 to 6 times, and the adhesion was assessed (as being qualified or unqualified) according to a proportion of the conductive ink being peeled off. The highest standard is defined as 5 B, which means no conductive ink being peeled off. The lowest standard is defined as 0 B. Greater than 65% of the conductive ink being peeled off is considered unqualified (NG), whereas being qualified would be PASS).

The stretched recovery rate was tested by following steps. 1. The initial resistance value R₀ of the sample was tested. 2. After the sample was stretched to a certain length, the sample was stayed static for 1 minute, and the resistance value R₁ was measured. 3. The sample was allowed to return back to the initial state, also stayed static for 1 minute. The resistance value R₂ was measured. Since the dimensional change of the sample after stretched recovery is very small, the accuracy of the experimental results cannot by ensured. Thus, the stretched recovery rate is defined by the resistance change rate before and after stretched recovery, which is calculated by formula (R₁−R₂)/(R₁−R₀).

The stretchable number was tested by following steps. 1. The sample having a certain original length was provided. The sample was stretched to a length of 150% of its original length, and then returned to its initial state. 3. The stretching step was repeated until the resistance value after being stretched was not greater than the 50% of its initial resistance value. The number of repetitions to that point was recorded as the stretchable number.

The preparation parameters and test results of Examples 1-6 and Comparative Examples 1-4 were recorded in Table 1.

TABLE 1

| | | | | | | | Comparative | Comparative | Comparative | Comparative |
|---|---|---|---|---|---|---|---|---|---|---|
| | Exa. 1 | Exa. 2 | Exa. 3 | Exa. 4 | Exa. 5 | Exa. 6 | Exa. 1 | Exa. 2 | Exa. 3 | Exa. 4 |
| SEBS rubber (%) | 68.72 | 68.72 | 0 | 0 | 68.72 | 68.72 | 78.72 | 68.72 | 24.8 | 24.8 |
| SBS rubber (%) | 0 | 0 | 0 | 0 | 0 | 0 | 0 | 10 | 0 | 0 |
| PVC (%) | 10 | 0 | 10 | 10 | 10 | 10 | 0 | 0 | 0 | 0 |
| PMMA (%) | 0 | 10 | 0 | 0 | 0 | 0 | 0 | 0 | 0 | 0 |
| Water-based PU (%) | 0 | 0 | 68.72 | 0 | 0 | 0 | 0 | 0 | 0 | 0 |
| Oil-based PU (%) | 0 | 0 | 0 | 68.72 | 0 | 0 | 0 | 0 | 0 | 0 |
| Metal powders | 0 | 0 | 0 | 0 | 7.09 | 4.256 | 0 | 0 | 74.4 | 75.2 |
| Conductive carbon | 21.28 | 21.28 | 21.28 | 21.28 | 14.19 | 17.024 | 21.28 | 21.28 | 0.8 | 0 |
| material | | | | | | | | | | |
| Initial resistance | 21.3 | 21.5 | 32 | 30.5 | 15.31 | 18.12 | 21.1 | 20.5 | 10.52 | 10.10 |
| value (Ω/cm) | | | | | | | | | | |
| Resistance value | 23 | 23.2 | 34.8 | 33 | 18.11 | 20.32 | 23.1 | 21 | 120 | 150 |
| after 50 washing and | | | | | | | | | | |
| drying processes | | | | | | | | | | |
| (Ω/cm) | | | | | | | | | | |
| Resistance change | 7.98 | 7.9 | 8.75 | 8.20 | 18.29 | 12.14 | 9.48 | 2.44 | 1040.68 | 1385.15 |
| rate (%) | | | | | | | | | | |
| Adhesion | PASS | PASS | PASS | PASS | PASS | PASS | PASS | PASS | NG | NG |
| Stretched recovery | 98.5 | 97 | 93 | 94.5 | 96.5 | 97 | 95 | 96 | 98 | 98 |
| rate (%) | | | | | | | | | | |
| Stretchable number | 700 | 500 | 500 | 500 | 500 | 500 | 500 | 500 | 500 | 500 |

From Table 1, the sensing electrodes made of the conductive inks of Examples 1-6 have greater stretchable number. Compared to Comparative Example 1-2, since the conductive inks of Examples 1-6 contain the plastic particles, the corresponding sensing electrodes have relatively higher stretched recovery rate.

Compared with Comparative Example 3-4, the conductive inks of Examples 1-6 contain no metal particles or only small amount of metal particles. Thus, the resistance change rate of the corresponding sensing electrodes is small. Compared with Examples 5-6 that contains the metal particles, the resistance change rate of the sensing electrodes of Examples 1-4 is small.

Compared with Example 3-4 that using PU as the flexible resin, Example 1-2 uses SEBS rubber as the flexible resin and that has a greater stretched recovery rate.

### Example 7

PVC particles, polyol (Yuanhe Company PAPI-27), and the conductive agent were mixed. Diisocyanate (Yuanhe Company XRP-3212) was added to obtain the foam-type conductive ink. The conductive agent was carbon nanotubes. The mass ratio of the PVC particles in the foam-type conductive ink was 15%. The mass ratio of the polyol in the foam-type conductive ink was 24.8%. The mass ratio of the diisocyanate is the foam-type conductive ink was 39.36%. The mass ratio of the conductive agent in the foam-type conductive ink was 21.28%.

### Example 8

The difference from Example 7 is that the plastic particles were PMMA particles.

### Comparative Example 5

The difference from Example 7 is that the conductive agent further included metal powders. The mass ratio of the metal powders in the foam-type conductive ink was 74.4%, and the mass ratio of the conductive carbon material in the foam-type conductive ink was 0.8%.

### Comparative Example 6

The difference from Example 7 is that the conductive agent was entirely of metal powders, and the mass ratio of the metal powder in the foam-type conductive ink was 75%.

The foam-type conductive ink prepared in Examples 7-8 and Comparative Examples 5-6 was stirred at 3000 rpm, and loaded into a mold to be foamed, thereby obtaining a foamed material. Then, the sensing electrode was made of the foamed material. The initial resistance value, the resistance value after 50 washing and drying processes, the adhesion, the stretched recovery rate, and the stretchable number of the sensing elements were tested. The preparation parameters and test results of Example 7 and Comparative Examples 5-6 were recorded in Table 2.

TABLE 2

| | | | Compar- | Compar- |
|---|---|---|---|---|
| | | | ative | ative |
| | Exa. 7 | Exa. 8 | Exa. 5 | Exa. 6 |
| Polyol (%) | 24.8 | 24.8 | 24.8 | 24.8 |
| Diisocyanate (%) | 39.36 | 39.36 | 39.36 | 39.36 |
| PVC(%) | 15 | 0 | 0 | 0 |
| PMMA(%) | 0 | 15 | 0 | 0 |
| Metal powders | 0 | 0 | 74.4 | 75 |
| Conductive carbon material | 21.28 | 21.28 | 0.8 | 0 |
| Initial resistance value | 25.7 | 28.3 | 10.52 | 10.10 |
| (Ω/cm) | | | | |
| Resistance value after 50 | 28.2 | 30.6 | 120 | 150 |
| washing and drying | | | | |
| processes (Ω/cm) | | | | |
| Resistance change rate(%) | 9.73 | 8.13 | 1040.68 | 1385.14 |
| Adhesion | PASS | PASS | NG | NG |
| Stretched recovery rate (%) | 97 | 96 | 90 | 90 |
| Stretchable number | 720 | 650 | 400 | 400 |

From Table 2, the sensing electrodes made of the foam-type conductive inks of Examples 7-8 have higher stretchable numbers. Compared with Comparative Examples 5-6, since the conductive inks of Examples 7-8 contain the plastic particles, the corresponding sensing electrodes have higher stretched recovery rate.

Compared with Comparative Examples 5-6, the conductive inks of Examples 7-8 contain no metal particles, so the resistance change rate of the corresponding sensing electrodes is small.

Although the embodiments of the present disclosure have been shown and described, those having ordinary skill in the art can understand that changes may be made within the principles of the present disclosure, up to and including the full extent established by the broad general meaning of the terms used in the claims. It will, therefore, be appreciated that the embodiments described above may be modified within the scope of the claims.

What is claimed is:

1. A conductive ink able to be stretched, comprising:
a flexible resin;
a plurality of plastic particles; and
a conductive agent;
wherein the plurality of plastic particles and the conductive agent are mixed in the flexible resin, the conductive agent comprises at least one conductive carbon material selected from a group consisting of conductive carbon black and carbon nanotube, and a mass ratio of the conductive carbon material in the conductive ink is in a range from 20% to 40%.

2. The conductive ink of claim 1, wherein the plurality of plastic particles is made of at least one of polyvinyl chloride, polymethyl methacrylate, polyethylene, and nylon.

3. The conductive ink of claim 1, wherein the conductive agent further comprises metal powders, and a mass ratio of the conductive carbon material with respect to the metal powders is greater than 2:1.

4. The conductive ink of claim 1, wherein a mass ratio of the flexible resin in the conductive ink is in a range from 60% to 80%.

5. The conductive ink of claim 1, wherein the flexible resin comprises at least one of a rubber-based resin and a polyurethane-based resin, the conductive ink further comprises a solvent, the solvent comprises at least one of toluene, high-flash aromatic naphtha, and ethylene glycol butyl ether.

6. The conductive ink of claim 5, wherein the rubber-based resin comprises at least one of styrene-ethylene-butene-styrene block copolymer rubber and styrene-butadiene-styrene copolymer rubber, and the polyurethane-based resin comprises an aqueous polyurethane or an oily polyurethane.

7. The conductive ink of claim 1, wherein the flexible resin comprises a two-fluid polyurethane, and the two-fluid polyurethane comprises a polyol and a diisocyanate.

8. The conductive ink of claim 7, wherein a density of the two-fluid polyurethane is less than 30 m³/kg.

9. The conductive ink of claim 1, wherein the flexible resin comprises at least one of a thermoplastic resin or a thermosetting resin, and the conductive ink further comprises a foaming agent.

10. A conductive element able to be stretched, comprising:
a conductive ink comprising:
a flexible resin;
a plurality of plastic particles; and
a conductive agent;
wherein the plurality of plastic particles and the conductive agent are mixed in the flexible resin, the conductive agent comprises at least one conductive carbon material selected from a group consisting of conductive carbon black and carbon nanotube, and a mass ratio of the conductive carbon material in the conductive ink is in a range from 20% to 40%.

11. The conductive element of claim 10, wherein the plurality of plastic particles is made of at least one of polyvinyl chloride, polymethyl methacrylate, polyethylene, and nylon.

12. The conductive element of claim 10, wherein the conductive agent further comprises metal powders, and a mass ratio of the conductive carbon material with respect to the metal powders is greater than 2:1.

13. The conductive element of claim 10, wherein a mass ratio of the flexible resin in the conductive ink is in a range from 60% to 80%.

14. The conductive element of claim 10, wherein the flexible resin comprises at least one of a rubber-based resin and a polyurethane-based resin, the conductive ink further comprises a solvent, the solvent comprises at least one of toluene, high-flash aromatic naphtha, and ethylene glycol butyl ether.

15. The conductive element of claim 14, wherein the rubber-based resin comprises at least one of styrene-ethylene-butene-styrene block copolymer rubber and styrene-butadiene-styrene copolymer rubber, and the polyurethane-based resin comprises an aqueous polyurethane or an oily polyurethane.

16. The conductive element of claim 10, wherein the flexible resin comprises a two-fluid polyurethane, and the two-fluid polyurethane comprises a polyol and a diisocyanate.

17. The conductive element of claim 16, wherein a density of the two-fluid polyurethane is less than 30 m³/kg.

18. The conductive element of claim 10, wherein the flexible resin comprises at least one of a thermoplastic resin or a thermosetting resin, and the conductive ink further comprises a foaming agent.
